(19) United States
(12) Patent Application Publication
(10) Pub. No.: US 2003/0108851 A1
(43) Pub. Date: Jun. 12, 2003

(54) Visual feedback methods and apparatus for weight loss and other forms of physical improvement

(76) Inventor: John G. Posa, Ann Arbor, MI (US)

Correspondence Address: John G. Posa, Gifford, Krass, Groh, Suite 400, 280 N. Old Woodward Ave., Birmingham, MI, 48009, US

(21) Appl. No.: 10/014,985

(22) Filed: Dec. 11, 2001

(51) Int. Cl. G09B 19/00; G09B 9/00; A63B 69/00

(52) U.S. Cl. 434/238; 434/247; 434/118; 434/307 R

(57) ABSTRACT

A health-related monitoring system and method provides visual feedback in the form of a computer-generated display of changes which will likely occur in a participant's body, if the person does, or does not, stay on a particular regime. A preferred method of assisting a person to achieve a desired body shape includes the steps of forming an initial image of the person (either in 2 or 3 dimensions) at an initial time; determining a progress level at intervals during a desired program, for example by imaging the person and comparing this image with the initial image so as to determine an image difference; and displaying a probable future image representative of a probable future body shape of the person based on the progress level of the person, for example as determined by the image difference and/or the body parameter difference, and displaying the ideal image to the person for comparison with the probable future image.

### FIELD OF THE INVENTION

This invention relates generally to physique improvement including weight loss, body-building and the like, and, in particular, to apparatus and methods providing visual feedback to encourage those engaged in such regimes.

### BACKGROUND OF THE INVENTION

It has long been recognized that feedback, both positive and negative, can be helpful in behavior modification programs of the type used to lose weight, quit smoking, and so forth. In terms of weight control, individuals occasionally plant pictures of themselves in an overweight condition on the refrigerator, or in their wallet or purse, to which they refer prior to eating in an effort to avoid over-indulging.

With modem computer technology and miniaturized electronic devices, new methods have become available to assist in diet/exercise programs and behavior modification in general. Various patents and pending applications are directed to the use of portable electronic devices acting as physiological monitors, which are then networked to expert systems or websites to analyze progress on a health-related activity or program. It has been proposed to use these remote sites to analyze various health-related phenomena input by multiple participants, to provide feedback in relation to progress toward better eating habits, weight control, cholesterol reduction, salt/sugar intake, and so forth. While such feedback may be provided in the form of textual messages or even charts/graphs highlighting historical or forward-looking trends, it would be advantageous to provide more realistic, explicit and compelling results in a visual, yet personalized form.

### SUMMARY OF THE INVENTION

This invention improves upon existing methods of health-related monitoring by providing visual feedback in the form of a computer-generated display of changes which will likely occur in a participant's body, if the person does, or does not, stay on a particular regime.

For example, a method of assisting a person to achieve a desired body shape comprises: forming an initial image of the person (either in 2 or 3 dimensions) at an initial time; forming a desired image of a desired body shape of the person, for example in consultation with a fitness adviser, other health professional, computer modeling program, or the like; providing a program to assist the person to achieve the desired body shape, such as a weight loss program, exercise program, nutraceutical or drug use program, or other program, or combination of programs; determining a progress level of the person at intervals during the program, for example by imaging the person and comparing this image with the initial image so as to determine an image difference, or measuring a body parameter such as waistline, body volume, body weight, body fat percentage, metabolic rate, and the like, and comparing the body parameter with an initial body parameter so as to determine a body parameter difference; displaying a probable future image representative of a probable future body shape of the person based on the progress level of the person, for example as determined by the image difference and/or the body parameter difference, and displaying the ideal image to the person for comparison with the probable future image Differences between the probable future image and the ideal image can be highlighted.

### BRIEF DESCRIPTION OF THE DRAWINGS

FIG. 1 is a drawing which shows how information is gathered according to the invention; and

FIG. 2 is a drawing of a screen display generated in accordance with the principles of the invention.

### DETAILED DESCRIPTION OF THE INVENTION

This invention allows a person engaged in a particular weight loss or other physical improvement program to obtain personalized, visual feedback in conjunction with their progress. Broadly according to the invention, one or more pictures are taken of a user, and these input to a computer system and modified for subsequent display as a function of time and historical/predicted achievements.

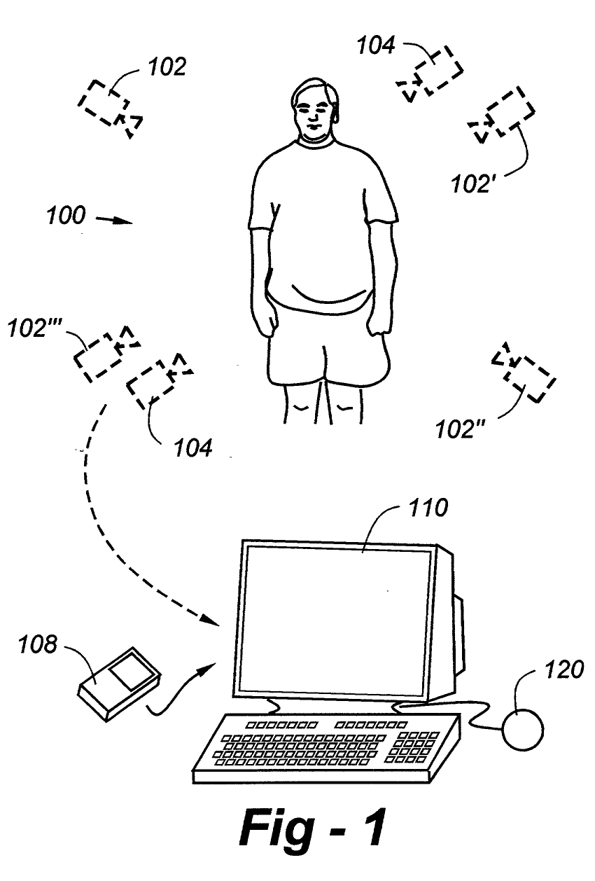

In FIG. 1, an individual 100 has pictures taken of him/herself, preferably at different angles and/or distances. The person may be clothed, in a bathing suit, or nude, depending upon the way they which to view themselves. In addition to full-body shots, taken with a camera at positions 102, 102′ and 102″, 102′″, closer views may be taken for “problem areas,” such as the neck or waist with cameras at positions 104, respectively. These images, preferably obtained using a digital camera, are input to computer 110 along with physiological or other information gathered in any manner, including portable unit 108, for example as described in Int. Pat. App. Nos. WO01/28495 and WO01/39089, all of which are incorporated herein by reference.

The images or other information may be manipulated by the computer 110 locally, or may be manipulated in conjunction with a remote site 120 through a local- or wide-area network such as the Internet. According embodiments of the invention, the image is modified in accordance with actual data such as current weight, existing clothing sizes, and so forth, in accordance with diet, exercise, metabolism, and other factors, to show the user they “will look” if they stay, or fall off, a particular diet/exercise regime.

For example, in a simple embodiment, a picture of a person's face or body from a frontal perspective is input to the system, along with their current weight, and measurements, for example, at the start of a diet or exercise program. Then, as the person inputs additional information on a periodic basis, such as how much weight they have lost, changes in their measurements, metabolic rate, caloric intake, and so forth, the picture or pictures are changed to reflect how they will look, should look, or could look at a particular point in time. In the event that multiple views of the individual are taken from different perspectives, the system may be sophisticated enough to create additional views through known interpolation and morphing techniques, enabling the individual to see how they will look from different perspectives in the future through rotation commands, for example.

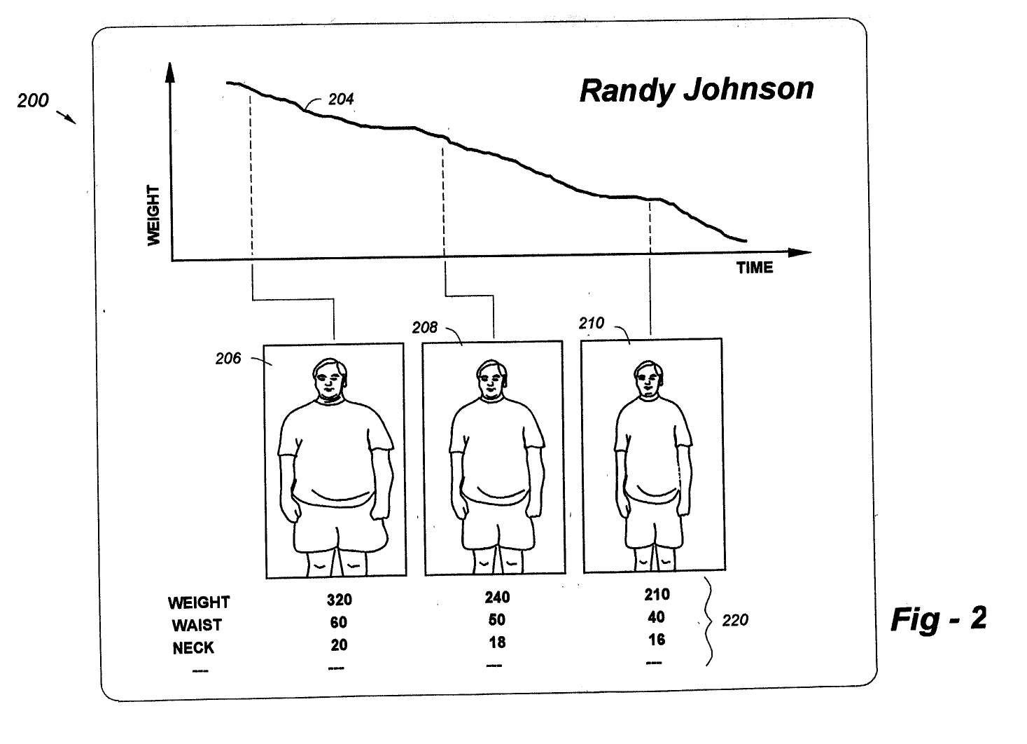

FIG. 2 is a screen displays which shows generally at 200 a personalized screen display for a particular individual using the system. The screen display is merely representative, insofar as the invention may utilize more or less information, different formats, and so forth.

At the top of the screen 200, there is shown a chart of weight vs. time. Below the graph are three images and, below that, additional information. Assuming that the individual just started the program with the first vertical broken line intersecting the curve 204, and that image 206 is an actual digital photograph taken by an individual in conjunction with the actual values below the image, this particular display shows at how, at two points in the future, the individual will look if they stay on a particular regime. It will be appreciated that, if there is no historical data available, the forward-looking information may be less accurate, compared to presentations that take previous activities and performance levels into account.

In the display of FIG. 2, it can be seen that, if the person keeps weight control in check according to graph 204, they can expect to reduce their weight from 320 shown in image 306, to 240 shown in image 208, with image 208 being generated by the system based upon the initial inputs. If they continue on the program, their weight will drop to 210, as shown in image 210, along with attendant reductions in weight, and measurements such as waist size, neck size, and so forth. In the preferred embodiment, the user may also click on a particular date (i.e., for a wedding or other event), in which case his/her appearance and/or other data will be displayed for that date. The system may also allow an individual to input a particular date (i.e., for a wedding, job interview, and so forth) to see how they will look on that day. Conversely, the user may not set a goal based upon a certain date, and the system will provide feedback in support of achieving that goal.

Web Camera

Images can be obtained by a camera connected to computer having communications link to a communications network, such as the Internet, such as what is conventionally referred to as a web camera. For example, a person stands in front of the camera, and a first image is recorded and transmitted to a remote computer system over the communications network. The person then stands in second orientation with respect to the camera, and a second image is recorded and transmitted to the remote computer system. Third, fourth, and additional images can be recorded.

The person can receive instructions, through a web page displayed on the computer, regarding positions, distances, and scale objects (such as rulers that the person can hold), for the purpose of image recording and scaling. The remote server then creates a stereoscopic representation of the person using the recorded images. The person can also transmit measurements, such as height, waist measurements and the like, for the purpose of increasing the accuracy of the stereoscopic representation. Over the course of a health maintenance program, the person can transmit modified measurements, allowing the stereoscopic representation to be modified. Predicted stereoscopic representations can be generated based on planned weight control programs, or projected body shapes based on the progress of a weight control program.

Health Management Program Selection

The images generated by embodiments of the present invention allow a person to select a health management program based on future prediction of appearance.

For example, a person may be presented with a choice of three weight loss programs, one based on reduced calorie intake only, another based on reduced calorie intake and mild activity, and a third based on maintaining calorie intake combined with intense activity. The body shape of the person can be predicted for each of the programs, allowing the person to select the weight loss program best conforming to his or her needs.

Body Volume Measurements

Three-dimensional imaging of a person's body, using imaging, scanning, or other method, allows the volume of the person's body to be determined. Volume can also be determined using a fluid displacement method. Volume changes can be predicted, based on planned diets of weight control programs, and used in projecting future shape of the person's body, or a body part. Volume changes can also be monitored during the course of a weight control program, and used to predict the future body shape of the person.

It is advantageous to combine volume measurements with one or more other parameters, so as to obtain further information on the person's body composition. Other parameters include weight, hydration level, body fat composition, and lean body weight. Weight can be obtained using scales. Hydration level and body fat composition can be obtained using bioimpedance methods, and other methods known in the arts. Lean body weight can be advantageously determined using a metabolic rate meter, such as an indirect calorimeter.

For example, a person is imaged, and body volume is determined. During a weight control program, volume changes will be distributed over certain body parts in a manner that can be predicted. For example, the head is unlikely to change volume significantly during a weight control program. Body parts comprising predominantly fat are likely to shrink relatively more than other body parts if weight loss is achieved while lean body weight is maintained. Conventional weight control programs fail to distinguish the origins of weight loss. During an improved weight control program, a person attempts to stabilize their metabolic rate at a rate close to a pre-program value, while losing body weight. The effect of this on the person's body shape is determined, and images are presented to the person at intervals so as to act as a motivational tool to aid success in the weight control program.

Demographic Data Used in Prediction

Predictions of body shape change due to the effects of a weight control program or other health maintenance program can use demographic data to assist accuracy. For example, a database can be constructed based on the effect of a weight control program on various individuals. Demographic data related to those individuals, such as start weight, height, age, ethnicity, gender, metabolic rate, body fat composition, and the like, and weight control program parameters such as weight loss, weight loss rate, exercise level, and the like, can be stored in the database. For a person newly enrolled in the weight control program, demographic data and weight control program parameters can be used as weighting factors in predicting the effects of the weight control program on the physique of the person.

Calorie Management System

In a calorie management system according to the present invention, a person records caloric intake using a diet log, records or estimates caloric expenditure due to physical activity, and determines caloric expenditure due to resting metabolism due using a metabolic rate meter such as an indirect calorimeter. An electronic device, such as a personal digital assistant (PDA), can be used to calculate a calorie balance for the person, for example as described in Int. App. WO01/28495. For example, the electronic device can comprise a display, a memory, a clock, a processor, and a data entry mechanism. The person records consumables consumed using a diet log program executed on the processor of the PDA, for example as described by Williams in U.S. Pat. Nos. 5,704,350 and 5,704,350, incorporated herein by reference. The software is further adapted to receive metabolic rate data for the person, receive estimates or measurements of activity, and to calculate a calorie balance for the person.

The display of the electronic device is then used to display images to the person, wherein the images are representative of a future appearance of the person based on the calorie balance for the person. The images may be determined by calculating a cumulative calorie balance over the elapsed duration of a weight control program, then extrapolating a final calorie balance over the planned duration of the weight control program.

Body imaging can also be used to detect inaccuracies in diet or activity logging. A current body image can be compared to an initial body image recorded at the start of a weight control program, and differences correlated with recorded activities and diet. Anomalies can be resolved by further questioning or counseling of the person. The weight control, fitness, or other health related program can be modified so as to help bring further adjust changes in the image of the person to be consistent with required goals.

Changes in the images of a person can be determined quantitively, using computer image analysis techniques known in the art, allowing a person, fitness trainer, or computer expert system to evaluate the effectiveness of a weight control, fitness, or other body-shape adjusting program. The program can be modified so as to allow further correlations between program elements (such as steroid use) and body shape change. In this way, an optimized steroid consumption can be determined, for example from the minimum consumption required to achieve a desired change in body form. Data can be collated for a number of individuals, allowing optimized programs to be established.

Interactive Television

An interactive television can also be used in embodiments of the present invention. The person views an interactive television, and transmits a current body image, and/or the value of one or more body parameters, to a set-top box or similar device, which may be incorporated in the housing of the interactive television as a unitary device. These data are transmitted to a remote server system, which generates images or videos of the person based on the data received. For example, a person may view a video representation of themselves, for example as represented by a probable future shape determined by a progress level on a weight control program. The video representation (or other image) may be clothed (in computer-generated clothing), partially clothed, or not clothed, and engaged in various activities, such as walking on a beach, running, waterskiing, mountain biking, scuba diving, rollerblading, computer programming, playing tennis, or interacting with other humans. The video representation may be engaged in a movie role. The videos may be purchased by the person.

Fashion Advice

The person can also view images of themselves in particular fashion clothing, and the effect of a weight control program on their appearance be computer generated. Clothing items can also be offered for sale to the person, for example over the Internet or interactive TV channel, based on current or projected future appearance. Clothing items can be customized for the person based on recorded or projected measurements. The purchase of an item based on projected measurements provides additional encouragement to the person to complete a weight loss program or other program.

Special Event Simulations

Computer simulations of the probable or ideal future shape of the person at a special event can be provided. For example, an image of the person can be generated in a wedding dress, which may be of particular interest to some persons, such as future brides. Other special events which can be simulated include graduation, celebrations, anniversaries, and the like.

Other embodiments of the invention will be clear to those skilled in the health arts.

Having described my invention, I claim:

1. A method of assisting a person to achieve a desired body shape, the method comprising:
providing a program to assist a person to achieve the desired body shape;
determining a progress level of the person at intervals during the program; and
displaying at least one image to the person during the program, wherein the images comprise at least one image representative of a probable future body shape of the person determined by the progress level.

2. The method of claim 1, wherein the step of providing a program includes the steps of:
taking a plurality of pictures of an individual from different perspectives;
gathering physiological data relative to the individual;
inputting said pictures and physiological data in a computer system;
inputting data regarding the individual's diet/exercise program into the computer system;
manipulating the input data to predict what the individual will look like in the future based on the individual following one of a plurality of predetermined diet/exercise regimes; and
providing the individual with the predetermined diet/exercise program.

3. The method of claim 2, wherein the step of determining a progress level includes:
inputting additional data on a periodic basis relative to the individual's activities and actual performance levels as a result of following the at least one predetermined diet/exercise regime;
manipulating the additional data to determine what the individual will look like at a particular time based on the individual maintaining his/her activities and performance levels; and
comparing the predicted data and the data based on the individual's activities and performance levels; and
determining the difference between the predicted data and the data based on the individual's activities and performance levels to determine a progress level.

5. The method of claim 2, wherein the plurality of pictures are taken with a digital camera.

6. The method of claim 5, wherein the digital camera transmits the pictures to a remote computer system.

7. The method of claim 5, wherein the computer system creates additional images by changing at least one of the plurality of pictures.

8. The method of claim 2, wherein the step of gathering physiological data includes determining an individual's body volume.

9. The method of claim 8, wherein the step of determining the progress level includes periodically monitoring the individual's body volume.

10. The method of claim 2, wherein the step of inputting data includes inputting demographic data.

11. The method of claim 2, wherein the step of inputting includes inputting data into a PDA.

12. The method of claim 11, wherein the step of inputting data includes inputting caloric intake data.

13. The method of claim 2, wherein the step of inputting data includes inputting data into an interactive television.

14. The method of claim 13, wherein the step of inputting the data into an interactive television further includes transmitting the data to a remote server that generates images of the individual based on the input data which are viewable on the interactive television.

15. The method of claim 14, wherein the generated images are viewed in fashion clothing selected by the individual from the remote server.

16. The method of claim 14, wherein the generated images are viewed as part of a computer simulation generated by the remote server on the interactive television.

17. The method of claim 2, wherein the step of providing the program includes displaying an image to a user of what the individual is predicted to look like in the future based on the individual following one of a plurality of predetermined diet/exercise regimes.
